(19) United States
(12) Patent Application Publication
(10) Pub. No.: US 2007/0080823 A1
(43) Pub. Date: Apr. 12, 2007

(54) Techniques for pairing remote controllers with host devices

(75) Inventors: Jack I-Chieh Fu, Milpitas, CA (US); Jesse Devine, Oakland, CA (US); Myra Haggerty, San Mateo, CA (US); Steve Hotelling, San Jose, CA (US)

Correspondence Address: BEYER WEAVER LLP, P.O. BOX 70250, OAKLAND, CA, 94612-0250, US

(73) Assignee: Apple Computer, Inc.

(21) Appl. No.: 11/245,937

(22) Filed: Oct. 7, 2005

(51) Int. Cl. G05B 19/02; G08C 19/00

(52) U.S. Cl. 340/825.22; 340/825.69

(57) ABSTRACT

Techniques for associating a wireless controller to a host device are disclosed. Once associated, the host device is responsive to the associated wireless controller but not responsive to other wireless controllers that may be in the vicinity. Subsequently, if desired, the association with the wireless controller can be removed and a different association with another wireless controller can be invoked. As an example, the wireless controller can be a portable remote controller, and the host device can be a personal computer, a home stereo, a portable media player, or a docking station for a portable media player. In one implementation, the portable remote controller can be an infrared remote controller.

### BACKGROUND OF THE INVENTION

1. Field of the Invention

The present invention relates to remote controllers and, more particularly, to multiple remote controllers operating in the same vicinity.

2. Description of the Related Art

Remote controllers are generally utilized today for controlling televisions, home stereos, and DVD players, and the like. Typically, when one buys such consumer electronic products, a corresponding remote controller is often provided. Typically, the remote controller is configured for use with the corresponding consumer electronic product and not otherwise generally useable. Here, vendor-specific and/or model-specific messages are transmitted by remote controllers and ignored by consumer electronic products that are from different vendors/models.

There are also universal remote controllers that can be used with a variety of different products. One type of universal remote controller is a learning remote controller. A learning remote controller is trained to operate with a given consumer electronic product by being programmed using an existing remote controller that already operates with the product. Another type of universal remote controller makes use of a database of the large number of different vendors and their products so that the appropriate data can be loaded into the remote controller and then used to control a specific consumer electronic product.

Bluetooth technology allows for local wireless communications between various devices. Bluetooth is a bi-directional wireless communications protocol that permits pairing, but is not well suited for remote controllers, such as infrared (IR) remote controllers.

Recently, remote controllers have begun to be utilized with computers. These remote controllers can mimic keyboard or mouse events for the computers. One solution uses an infrared receiver device that connects to a Universal Serial Bus (USB) port of a computer via a USB cable, and an infrared remote controller that uses infrared transmissions that can be received by the infrared receiver device and supplied to the computer. For example, such a remote controller allows a user to control multimedia applications on the computer. This approach is an aftermarket solution to provide remote control capabilities to existing computers. Another solution connects a receiver device to an Airport Express® unit that wirelessly transmits to a corresponding wireless transceiver within the computer, such as a Macintosh computer from Apple Computer, Inc. Airport Express® is Apple Computer's mobile base station that features analog and digital audio outputs that can be connected to a home stereo, and enables users to wirelessly stream music from iTunes® media management program on their computer to any room in the house. Still another solution uses Bluetooth compatible handheld devices, such as a mobile phone, to serve as a remote controller for a Macintosh computer. This solution requires installation of software on the mobile phone as well as the computer. Once the software is installed, the mobile phone can be used to control popular programs such as iTunes® media management program from Apple Computer, Inc. For example, in controlling iTunes® media management program using this solution, the user can use the directional controls on the mobile phone to change listing volume, skip forward and backward, play/pause, etc.

Unfortunately, however, existing approaches to providing and utilizing remote controllers not only are cumbersome and lack flexibility but also are not well suited for multiple transmitter and multiple receiver environments. Accordingly, there is a need for improved techniques to facilitate use of remote controllers with electronic devices.

### SUMMARY OF THE INVENTION

Generally speaking, the invention pertains to techniques for associating a wireless controller to a host device. Once associated, the host device is responsive to the associated wireless controller but not responsive to other wireless controllers that may be in the vicinity. Subsequently, if desired, the association with the wireless controller can be removed and a different association with another wireless controller can be invoked. As an example, the wireless controller can be a portable remote controller, and the host device can be a personal computer, a home stereo, a portable media player, or a docking station for a portable media player. In one implementation, the portable remote controller can be an infrared remote controller.

According to another aspect, a wireless controller (e.g., portable remote controller), which is battery powered, can transmit a low battery condition indication when such condition exists. A host device, upon receipt of the low battery condition indication, can notify the host device and/or its user.

The invention can be implemented in numerous ways, including as a method, system, device, apparatus, or computer readable medium. Several embodiments of the invention are discussed below.

As a method for associating a portable remote controller to one of a plurality of host devices (e.g., in a dwelling), one embodiment of the invention includes at least the acts of: temporarily disabling all but a desired one of the host devices from receiving wireless transmissions from the portable remote controller; receiving a user interaction with the portable remote controller to provide a pairing request; wirelessly transmitting the pairing request from the portable remote controller; receiving the pairing request at the desired one of the host devices but not at any of the other host devices; and pairing the portable remote controller to the desired one of the host devices.

As a method for receiving and processing a user command at a host device, with the user command being wirelessly transmitted from a portable remote controller to the host device, one embodiment of the invention includes at least the acts of: receiving at least the user command and a device identifier that were transmitted from the portable remote controller to the host device in a wireless manner, where the device identifier pertains to the portable remote controller; comparing the received device identifier with a previously stored device identifier at the host device; and executing the received user command when the comparing indicates that the received device identifier matches the previously stored device identifier, and not executing the received user command when the comparing indicates that the received device identifier does not match the previously stored device identifier.

A method for associating a portable remote controller to a host device, one embodiment of the invention includes at least the acts of: receiving a user input with respect to the portable remote controller; identifying a command associated with the user input; transmitting a control packet to the host device, the control packet including at least the command and a device identifier; receiving the control packet at the host device; acquiring at least the received command and the received device identifier from the received control packet; comparing the received device identifier with a previously stored device identifier at the host device; and executing the received command when the comparing indicates that the received device identifier matches the previously stored device identifier, and not executing the received command when the comparing indicates that the received device identifier does not match the previously stored device identifier.

As a wireless control system for remotely controlling a host device by a portable remote controller, one embodiment of the invention includes at least a portable remote controller and a host device. The portable remote controller includes at least: a user input device for receiving a user input; a persistent memory that stores a device identifier for the portable remote controller; a controller for identifying a command associated with the user input; and a transmitter for transmitting a control packet to the host device, the control packet including at least the command and the device identifier. The host device includes at least: a receiver for receiving the control packet; and a controller for (i) acquiring at least the received command and the received device identifier from the received control packet, (ii) comparing the received device identifier with a previously stored device identifier at the host device, and (iii) executing the received command when the comparing indicates that the received device identifier matches the previously stored device identifier, and not executing the received command when the comparing indicates that the received device identifier does not match the previously stored device identifier.

As a computer readable medium including at least computer program code for receiving and processing a user command at a host device, with the user command being wirelessly transmitted from a portable remote controller to the host device, one embodiment of the invention includes at least: computer program code for receiving at least a user command and a device identifier that were wirelessly transmitted from the portable remote controller to the host device, where the device identifier pertains to the portable remote controller; and computer program code for executing the received command only when the received device identifier matches the previously stored device identifier.

As computer readable medium including at least computer program code for associating a portable remote controller to one of a plurality of host devices, one embodiment of the invention includes at least: computer program code for configuring a desired one of the host devices to pair with a portable remote controller; computer program code for receiving a request at the desired one of the host devices, the request being provided via wireless transmission from the portable remote controller; and computer program code for at least pairing the portable remote controller to the desired one of the host devices in response to the request.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a wireless control system according to one embodiment of the invention.

FIG. 2 is a flow diagram of a pairing process according to one embodiment of the invention.

FIG. 3 is a diagram of a wireless control system according to one embodiment of the invention.

FIG. 4 is a flow diagram of a remote controller process according to one embodiment of the invention.

FIG. 5 is a flow diagram of a transmit process according to one embodiment of the invention.

FIG. 6 is a schematic diagram of a packet format according to one embodiment of the invention.

FIG. 7 is a flow diagram of a host process according to one embodiment of the invention.

FIG. 8 is a flow diagram of a command execution process according to one embodiment of the invention.

FIG. 9 is a flow diagram of a low battery notification process according to one embodiment of the invention.

FIG. 10 is a perspective view of a remote controller suitable for use in one embodiment of the invention.

### DETAILED DESCRIPTION OF THE INVENTION

The invention pertains to techniques for associating a wireless controller to a host device. Once associated, the host device is responsive to the associated wireless controller but not responsive to other wireless controllers that may be in the vicinity. Subsequently, if desired, the association with the wireless controller can be removed and a different association with another wireless controller can be invoked.

In one embodiment, the host device includes a receiver to receive signals wirelessly transmitted by a transmitter in the wireless controller. For example, the wireless controller can be a portable remote controller, and the host device can be a personal computer, a home stereo, a portable media player, or a docking station for a portable media player. In one implementation, the portable remote controller can be an infrared remote controller.

In one embodiment, a wireless controller (e.g., portable remote controller), which is battery powered, can transmit a low battery condition indication when such condition exists. A host device upon receipt of the low battery condition indication can notify the host device and/or its user.

The invention is well suited for environments, such as a home or office environment, where multiple wireless controllers and multiple host devices are present. The ability to associate (e.g., pair) one of the wireless controllers to one of the host devices facilitates utilization of multiple wireless controllers and multiple host devices in the same environment. Here, once associated, like wireless controllers can independently control separate host devices.

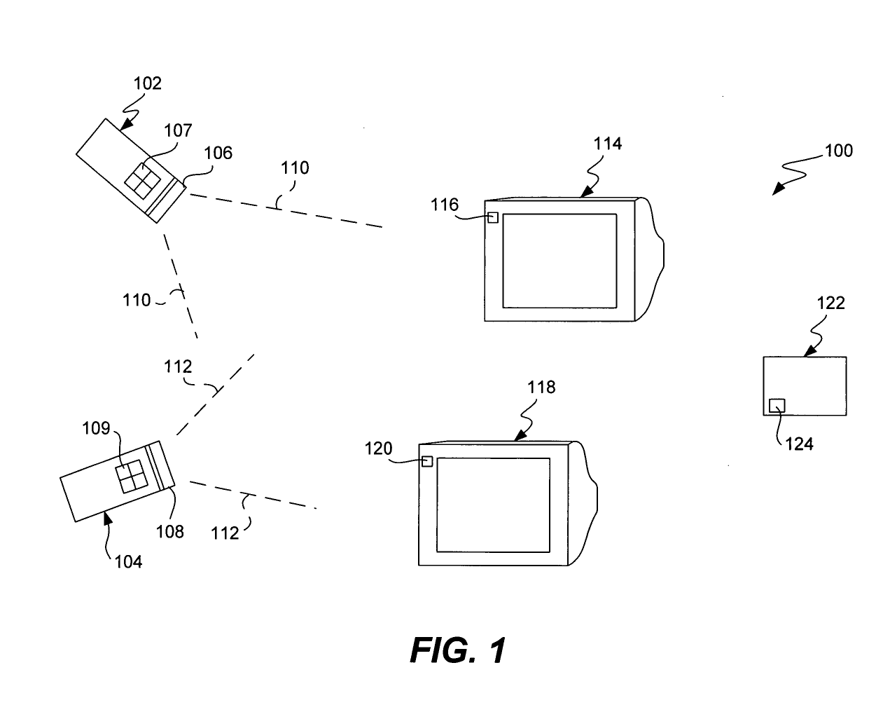

Embodiments of this aspect of the invention are discussed below with reference to FIGS. 1-10. However, those skilled in the art will readily appreciate that the detailed description given herein with respect to these figures is for explanatory purposes as the invention extends beyond these limited embodiments.

FIG. 1 is a block diagram of a wireless control system 100 according to one embodiment of the invention. The wireless control system 1000 includes portable remote controllers 102 and 104. The portable remote controller 102 includes a wireless transmission window 106 and one or more user input devices 107. Similarly, the portable remote controller 104 includes a wireless transmission window 108 and one or more user input devices 109. When a user of the remote controller 102 activates one or more of the user input devices 107, a wireless signal 110 is transmitted (by a transmitter) outward from the wireless transmission window 106. Likewise, when a user activates one or more of the user input devices 109, a wireless signal 112 is transmitted (by a transmitter) outward from the wireless transmission window 108. In this embodiment, the portable remote controllers 102 and 104 are similar remote controllers. In one implementation, the portable remote controllers 102 and 104 are identical, at least functionally, except for their internally stored device identifier discussed below.

The wireless control system 100 also includes a plurality of host devices that can be controlled by wireless signals transmitted by the portable remote controllers 102 and 104. As shown in FIG. 1, the host devices provided in the wireless control system 100 include a first host device 114 that includes a wireless receiver window 116, a second host device 118 that includes a wireless receiver window 120, and a third host device 122 that includes a wireless receiver window 124. When the wireless signals 110 or 112 are transmitted, any of the host devices 114, 118 and 122 which are in the vicinity and in the appropriate position can capture (via a receiver) the wireless signals 110 or 112. In response to a received wireless signal, any of the host devices 114, 118 or 122 can activate a command. More particularly, the wireless receiver window 116 of the host device 114 can receive one or both of the wireless transmission signals 110 and 112. Likewise, the wireless receiver window 120 of the host device 118 can also receive one or both of the wireless transmission signals 110 and 112. Still further, the wireless receiver window 124 of the host device 122 can also receive either or both of the wireless transmission signals 110 and 112.

Consequently, if both of the portable remote controllers 102 and 104 are present in the same general vicinity as the host devices 114, 118 and 122, the sending of a wireless signal from either of the portable remote controllers 102 and 104 can be received by one or more of the host devices 114, 118 and 122. Accordingly, it is likely that a user attempting to control one of the host devices would inadvertently also control other of the host devices. In addition, since there are two portable remote controllers 102 and 104, it is also possible that another user that is using the portable remote controller 104 would inadvertently interfere with the intended actions by the user of the portable remote controller 102.

Although the portable remote controllers 102 and 104 are typically line of sight devices, when operated indoors, there tends to be a number of reflections of the wireless transmissions. As a result, the ability for a user to control the direction of a wireless transmission from a portable remote controller is difficult. Hence, in the environment illustrated in FIG. 1, it is difficult for users to control operation of particular host devices without inadvertent control of other host devices in the vicinity. However, according to one aspect of the invention, a portable remote controller can be associated with a particular host device. Once a host device is associated with a portable remote controller, the host device only responds to wireless transmissions from that corresponding portable remote controller. For example, if the portable remote controller 102 were associated (e.g., paired) with the host device 114, any wireless signals 110 from the portable remote controller 102 would be received via the wireless receiver window 116 and processed by the host device 114. However, if the host devices 118 and 122 are likewise paired with other portable remote controllers (or have their receivers deactivated), such wireless signals 110 would be ignored by the host devices 118 and 122, even if received via the wireless receiver windows 120 and 124, respectively. Also, the portable remote controller 104 can be similarly paired to either the host device 118 or the host device 122.

Beyond management-type commands (used to request pairing/unpairing or status operations), a remote controller can also support various other commands that are understood by host devices and enable host devices to manipulate various applications provided at the host devices. For example, a host device can provide a media player functionality, and the remote controller can be used to interact with a media player, such as by providing media play back controls. Examples of media based commands that can be sent from a portable remote controller to a host device include a menu request, play/pause, next track, previous track, volume up, volume down.

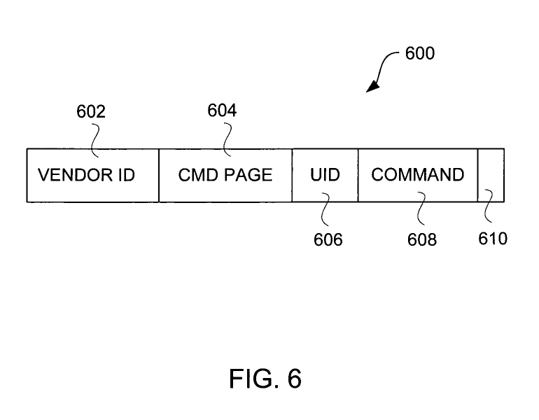

In one embodiment, the wireless transmission from the portable remote controller to a host device is achieved using infrared (IR) transmissions. The infrared transmissions are transmitted from a transmitter within a portable remote controller to one or more receivers within one or more host devices that are within line of sight (directly or via reflections) of the one or more portable remote controllers. As one example, the transmission can conform to an adaptation of the NEC infrared remote control transmission format. The NEC infrared remote control transmission format supports two kinds of packets, standard packets and repeater packets. In general, standard packets include user commands. Repeater packets contain no user command but indicate that the user is repeating the previous user action (e.g., a button being held down). The adapted packet format for control packets (i.e., standard packets) according to one embodiment are discussed below with reference to FIG. 6.

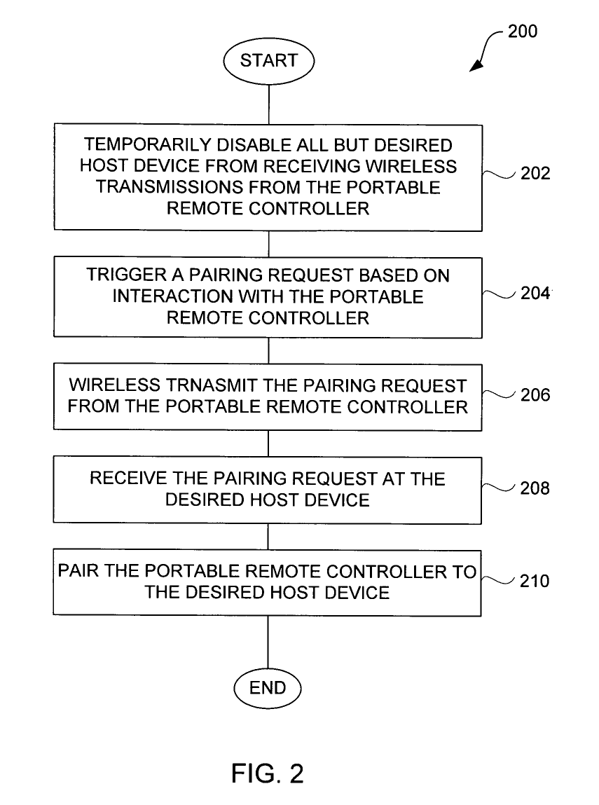

FIG. 2 is a flow diagram of a pairing process 200 according to one embodiment of the invention. The pairing process 200 is a process concerned with associating (e.g., pairing) a portable remote controller to a particular host device.

The pairing process 200 temporarily disables 202 all but a desired host device from receiving wireless transmissions from the portable remote controller. For example, the wireless transmission window of a host device can be shielded to block any wireless transmissions (e.g., infrared transmissions) from being received by the corresponding host device. As another example, the one or more host devices that are not to receive the wireless transmissions can either disable or power-off their wireless receivers.

Next, a pairing request is triggered 204 based on user interaction with the portable remote controller. For example, using one or more user input devices of the portable remote controller, the user can initiate a pairing request. The pairing request is then wirelessly transmitted 206 from the portable remote controller. Once the pairing request is transmitted 206, any host devices (having compatible receivers) within the vicinity are able to pick-up the wireless transmission and process the pairing request. However, since all but the desired host device have been disabled, only the desired host device should receive 208 the pairing request. The desired host device can then pair 210 the portable remote controller to the desired host device. Following the block 210, the pairing process 200 is complete and ends.

In an alternative embodiment, a pairing process could cause the desired host device to entering a pairing mode. While in the pairing mode, the desired host device would operate to pair itself with a remote controller that next transmits a next incoming transmission that the desired host device receives. Once paired, the desired host device would exit the pairing mode. In this embodiment, other host devices (besides the desired host device) do not need to be disabled.

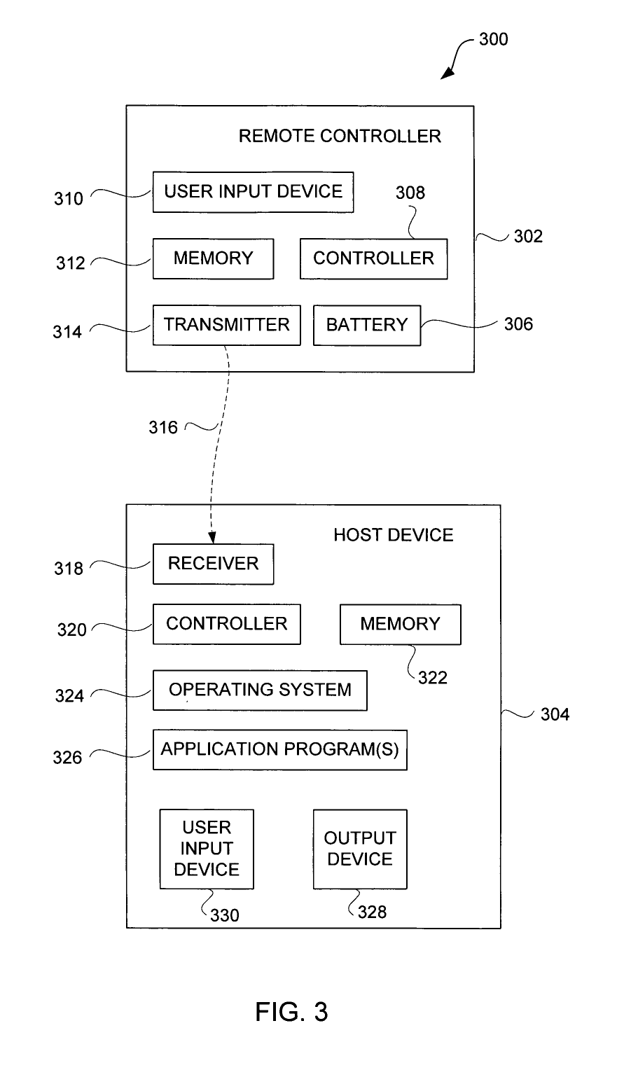

FIG. 3 is a diagram of a wireless control system 300 according to one embodiment of the invention. The wireless control system 300 includes a remote controller 302 and a host device 304. As an example, the remote controller 302 can represent the portable remote controller 102 illustrated in FIG. 1, and the host device 304 can represent the host device 114 illustrated in FIG. 1.

The remote controller 302 is a low power device and thus can be powered by a battery 306. The remote controller 302 also includes at least a controller 308, a user input device 310 and a memory 312. The controller 308 controls the overall operation of the remote controller 302. The user input device 310 enables a user to interact with the remote controller 302, such as to request an operation with respect to the host device 304. The memory 312 provides persistent data storage for various elements, including program code, identifier(s), data structures, etc. Still further, the remote controller 302 includes a transmitter 314. In one embodiment, the transmitter 314 is an infrared (IR) transmitter. The transmitter 314 can output a wireless transmission 316. Typically, the wireless transmission 316 is directed toward the host device 304.

The host device 304 includes a receiver 318 for the wireless transmission 316. The host device 304 includes at least a controller 320, a memory 322, an operating system 324, application program(s) 326, an output device 328 and a user input device 330. The controller 320 controls the overall operation of the host device 304. The memory 322 can be used to store persistent data, including program code (e.g., for the operating system 324 and the application program(s) 326), identifier(s), data structures, etc. The operating system 324 together with the controller 320 enables the host device 304 to not only wirelessly receive transmissions from the remote controller 302, but to also support and operate one or more application programs 326 as well as to utilize the output device 328 and the user input device 330.

The remote controller 302 can communicate with the host device 304 over a wireless link 316. As a result of such communication, the operation of the host device 304 can be manipulated by a user of the remote controller 302. In this embodiment, the communication is un-idirectional—from remote controller 302 to the host device 304. However, in other embodiments, the communication could be bi-directional.

According to one aspect of the invention, the remote controller 302 can be paired with the host device 304. When paired, the host device 304 is responsive to only the remote controller 302. Hence, if there are other remote controllers in the vicinity of the host device 304, the host device 304 understands to ignore wireless communications from such other remote controllers. In contrast, when unpaired, the host device 304 is responsive to any compatible remote controllers in the vicinity.

Additional details are discussed below for the operations associated with pairing or unpairing remote controllers to host devices.

When paired, a user of the remote controller 302 can interact with the one or more application programs 326 operating on the host device 304. For example, one type of application program 326 is a media player program capable of playing digital media assets stored in the memory 322 or some other memory accessible by the host device 304. Hence, the user of the remote controller 302 can interact with the user input device 310 of the remote controller 302 to manipulate media playback controls, such as volume changes, next track, previous track, and play and pause operations associated with the media player program. For other types of application programs 326 available at the host device 304, the particular controls or commands being provided by the remote controller 302 to the host device 304 can vary widely depending upon the application.

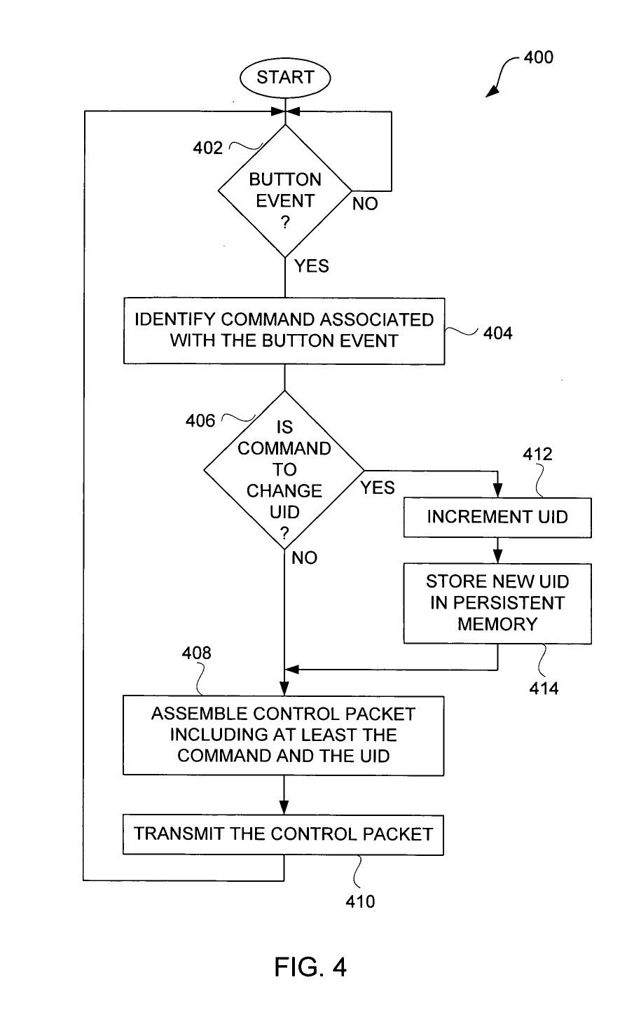

FIG. 4 is a flow diagram of a remote controller process 400 according to one embodiment of the invention. The remote controller process 400 is, for example, performed by a portable remote controller, such as the portable remote controllers 102 and 104 illustrated in FIG. 1.

The remote controller process 400 begins with a decision 402 that determines whether a button event has occurred. In this embodiment, the button event is a representative user input action with respect to the portable remote controller. When the decision 402 determines that a button event has not occurred, then the remote controller process 400 awaits such an event. Once the decision 402 determines that a button event has occurred, then the remote controller process 400 continues. In other words, the remote controller process 400 is effectively invoked when a button event has occurred.

After a button event has occurred, a command associated with the button event is identified 404. Here, the particular button or combination of buttons being pressed on the portable remote controller are assigned to particular commands. Hence, the command being identified 404 is based upon the one or more buttons associated with the button event.

Next, a decision 406 determines whether the command is to change a device identifier (UID) associated with the portable remote controller. Each portable remote controller has a pseudo-unique device identifier (UID) that is stored in the portable remote controller (e.g., memory 312). The portable remote controller supports various different commands. However, the command to change the device identifier (UID) is a command that causes an action at the portable remote controller. Hence, additional processing is performed when the command is to change the device identifier (UID). One reason for the command to change the device identifier (UID) is that two remote controllers in the same vicinity may, by chance, have the same device identifier (UID), since the device identifier (UID) is only pseudo-unique. Hence, the ability to affect a change to one of the remote controllers enables the remote controller to thereafter work independently in the same vicinity.

When the decision 406 determines that the command is not to change the device identifier (UID), then a control packet including at least the command and the device identifier (UID) is assembled 408. After the control packet is assembled, the control packet is transmitted 410. In one embodiment, the transmission of the control packet is performed by the transmission of infrared signals in a particular direction, namely, the direction in which the portable remote controller is pointed. Following the block 410, the remote controller process 400 returns to repeat the decision 402 and subsequent blocks so that additional button events can be similarly processed.

On the other hand, when the decision 406 determines that the command is to change the device identifier (UID), additional processing is performed at the portable remote controller. Namely, the existing device identifier (UID) is incremented 412. Then, the new device identifier (UID) is stored 414 in persistent memory (e.g., memory 312). Following the block 414, the remote controller process performs the block 408 and subsequent blocks with respect to a pairing command. In this case, after the device identifier is changed, the change device identifier command is effectively thereafter processed as a pairing command so that the portable remote controller can be re-paired with an appropriate host device.

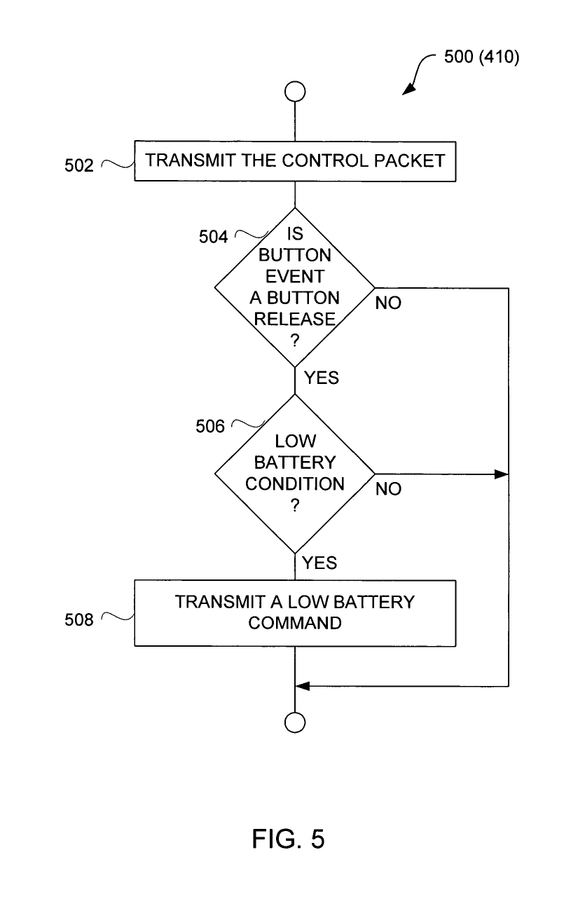

FIG. 5 is a flow diagram of a transmit process 500 according to one embodiment of the invention. The transmit process 500 is, for example, processing associated with the block 410 illustrated in FIG. 4. According to the transmit process 500, the control packet is transmitted 502. Then, a decision 504 determines whether the button event being processed is a button release. In one embodiment, a button event can be classified as a button press (button down event) or a button release (button up event). When the decision 504 determines that the button event is not a button release, then the transmit process 500 ends and no additional processing is needed in this situation. On the other hand, when the decision 504 determines that the button event is a button release, then a decision 506 determines whether a low battery condition exists. As previously noted, the portable remote controller is typically battery operated. When the available charge in the battery is low, a low battery condition exists. Hence, when the decision 506 determines that the low battery condition does not exist, such as when the battery is adequately charged, the transmit process 500 also ends. Alternatively, when the decision 506 determines that a low battery condition is present, then a low battery command is transmitted 508 such as in a status packet. Here, it should be noted that the low battery command is transmitted 508 only on specific events. If the low battery command is transmitted 508, it is transmitted subsequent to the transmission of the control packet.

FIG. 6 is a schematic diagram of a packet format 600 according to one embodiment of the invention. The packet format 600 is the format of the data within a packet, such as a control packet or a status packet as noted above. The packet format 600 includes a vendor identifier (ID) 602, a command page 604, a device identifier (UID) 606, a command field 608, and a parity bit 610. A receiver at a host device can use the vendor identifier to limit utilization with respect to one or more particular vendors. The command page 604 provides for logical groupings of commands. The command page 604 is an identifier that allows for classifying of commands into logical groups but does not necessarily correlate to physical devices or model lines. Typically, receivers of host devices interpret all commands received within the context of the command page specified. The device identifier (UID) 606 provides a unique identifier or a pseudo-unique identifier for a remote controller. The device identifier (UID) is used for the pairing operations. In one embodiment, the device identifier is only pseudo-unique because it contains only a fixed number of unique values. The command field 608 specifies the particular command being requested by the remote controller that sends the packet. The command provided in the packet format 600 can specify a user command, action, status or event. Examples of commands include a paring request, a reset to factory default, low battery condition, repeater packet, remove pairing request, etc. The parity bit 610 provides for basic error correction with respect to the packet.

According to one implementation of the packet format 600 illustrated in FIG. 6, the vendor identifier 602 is 11 bits in length and can represent a fixed vendor identifier, such as an identifier representing the manufacturer of the remote controller. The command field 608 can use a 5 bit unsigned number to specify a command. The device identifier can be an 8 bit unsigned number which would support only 256 unique values. At manufacturer each remote controller would be assigned a device identifier, and the assigned device identifier would be stored in persistent memory. The assigning of the device identifiers can be randomly performed or can be achieved in a serial process where the device identifier is continuously incremented. The command field can be a 7 bit number. The parity bit provides basic error checking by setting the parity bit to 0 or 1 depending upon the other bits in the packet.

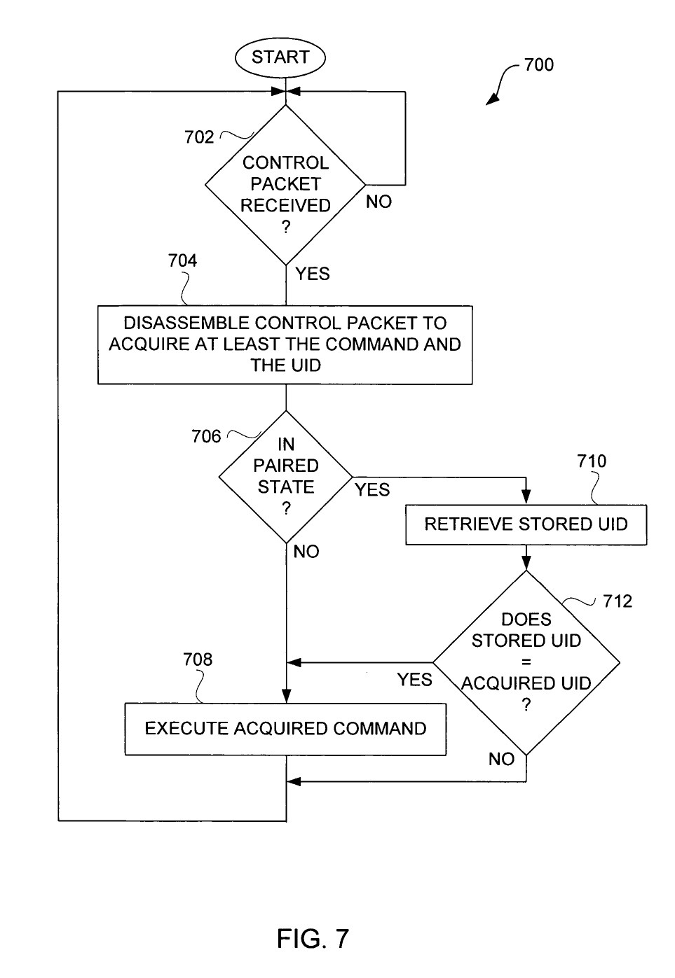

FIG. 7 is a flow diagram of a host process 700 according to one embodiment of the invention. The host process 700 is, for example, performed by a host device, such as the host device 114, 118 or 122 illustrated in FIG. 1.

The host process 700 begins with a decision 702. The decision 702 determines whether a control packet has been received. Here, the control packet would be received by a receiver within a host device and then examined within the host device. When the decision 702 determines that a control packet has not yet been received, the host process 700 awaits such a packet. Once the decision 702 determines that a control packet has been received, the host process 700 continues. In other words, the host process 700 is effectively invoked when a control packet is received at the host device.

After a control packet has been received, the control packet is disassembled 704 to acquire at least the command and the device identifier (UID). For example, a representative format for the control packet is depicted in FIG. 6. Next, a decision 706 determines whether the host device is in a paired state. When the decision 706 determines that the host device is not in a paired state, then the host device is receptive to all incoming packets that can be recognized. Hence, in this case, the acquired command is executed 708.

Alternatively, when the decision 706 determines that the host device is already in a paired state, a stored device identifier (UID) is retrieved 710. For example, the stored device identifier can be retrieved 710 from the memory of the host device. A decision 712 then determines whether the stored device identifier is the same as the device identifier acquired from the control packet that has been received. When the decision 712 determines that the stored device identifier is the same as the acquired device identifier, then the acquired command is also executed 708. Here, it is determined that the control packet has been received from the remote controller that is paired with the host device; hence, it is appropriate for the acquired command to be executed 708. On the other hand, when the decision 712 determines that the stored device identifier does not match the acquired device identifier, the acquired command is not executed because the block 708 is bypassed. Finally, following the block 708 or its being bypassed by the decision 712, the host process 700 returns to repeat the decision 702 and subsequent blocks so that subsequent control packets can be similarly processed.

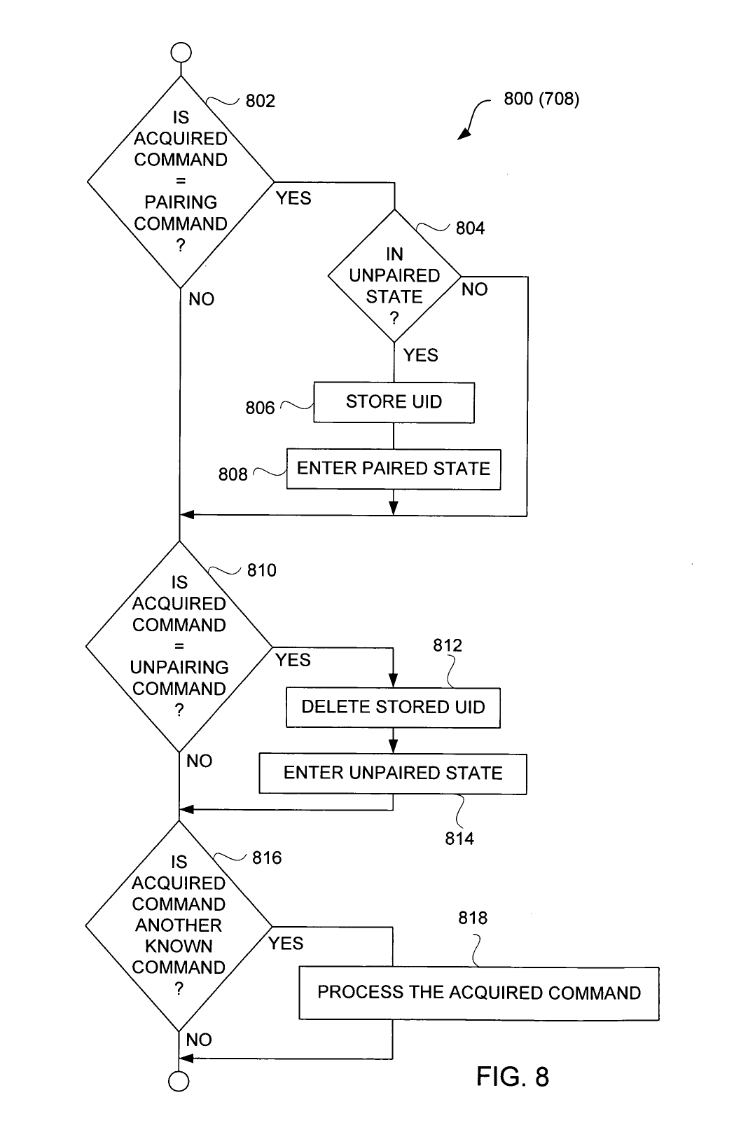

FIG. 8 is a flow diagram of a command execution process 800 according to one embodiment of the invention. The command execution process 800 is, for example, processing that can be associated with the block 708 illustrated in FIG. 7.

The command execution process 800 begins with a decision 802 that determines whether the acquired command is a pairing command. When the acquired command is a pairing command, then a decision 804 determines whether the host device is in an unpaired state. When the decision 804 determines that the host device is not in an unpaired state, meaning that the host device is already paired, the acquired command is ignored since the host device is already paired. On the other hand, when the decision 804 determines that the host device is in the unpaired state, the device identifier (UID) for the portable remote controller supplying the pairing command is stored 806 at the host device. Then, the paired state is entered 808. At this point, the portable remote controller is paired to the host device.

When the decision 802 determines that the acquired command is not a pairing command (or following blocks 804 or 808), a decision 810 determines whether the acquired command is an unpairing command. When the decision 810 determines that the acquired command is an unpairing command, the stored device identifier (UID) is deleted 812. For example, the stored device identifier (UID) is the identifier previously stored at block 806. After the stored device identifier (UID) is deleted 812, the unpaired state is entered 814. At this point, although the portable remote controller was previously paired with the host device, the portable remote controller is no longer paired with the host device.

Alternatively, when the decision 810 determines that the acquired command is not an unpairing command (or following the block 814), a decision 816 determines whether the acquired command is another known command. When the decision 816 determines that the acquired command is another known command, the acquired command can be processed 814. The host device can process various other commands in this regard, such as those pertaining to its particular functionality or supported applications. For example, a host device may support a media player and thus the acquired command can be a command associated with media playback controls for the media player. However, there are various other applications and uses that can be provided at a host device.

On the other hand, when the decision 816 determines that the acquired command is not another known command (or following the block 818), the command execution process 800 ends.

In one embodiment, the portable remote controller can send a low battery condition command to a host device, when the battery is in a low battery state. However, in one implementation, to avoid excessive signaling, a single low-battery condition is sent only after a button-down and a corresponding button-up event has occurred. This allows repeater packets to be transmitted as long as the button is held down without excessively sending the low-battery condition command. Hence, only when the button is subsequently released and the repeater packet stopped does a single low-battery condition command be transmitted. Upon receiving a low battery condition command, a host device can take action to notify the host device or its user.

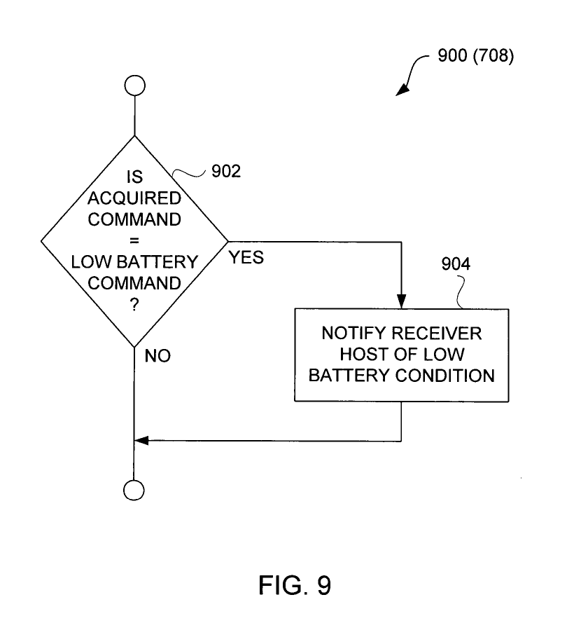

FIG. 9 is a flow diagram of a low battery notification process 900 according to one embodiment of the invention. The low battery notification process 900 can optionally be performed by a host device to inform the host device or its user of the battery status of a battery of a portable remote controller. This processing 900 can be associated with the block 708 and thus performed in a manner similar to processing of other commands. A packet containing a low battery command can be considered a status packet. In one embodiment, a status packet is one type of control packet.

The low battery notification process 900 includes a decision 902 that determines whether the acquired command is a low battery command. When the decision 902 determines that the acquired command is a low battery command, then a host program is notified 904 of the low battery condition for the portable remote controller. In one embodiment, once notified, the host program operates to notify the user of the host device. This notification to the user can be performed in a variety of different ways. For example, the notification can display a message on a display screen, flash a light indicator, or various other ways. On the other hand, when the decision 902 determines that the acquired command is not a low battery command, the block 904 is bypassed.

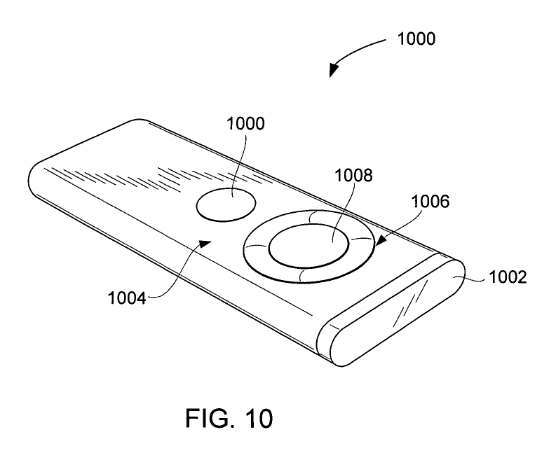

The wireless controller or portable remote controller used herein can have many different shapes and configurations. FIG. 10 is a perspective view of a remote controller 1000 suitable for use in one embodiment of the invention. The remote controller 1000 is, for example, suitable for use as the portable remote controllers 102 and 104 illustrated in FIG. 1. The remote controller 1000 is lightweight, low powered and highly portable. Typically, the remote controller 1000 is small enough to be easily held within a single hand of its user. The remote controller 1000 includes a wireless transmission window 1002 through which transmitted wireless (e.g., infrared) signals can be output. The remote controller 1000 also includes user input devices 1004. In this embodiment, the user input device 1004 includes a set of four input buttons 1006 arranged in a circular fashion, a center button 1008 that is surrounded by the set of four input buttons 1006, and another button 1010. These various buttons can, for example, be implemented by mechanical switches or touch-sensitive surfaces. These buttons can be mapped to various different functions depending on the particular application program on a host device that is being controlled by the remote controller 1000. For example, if the application program on the host device being controlled is a media player application, then the user input device 1004 can provide media playback controls. As an example, the set of four input buttons 1006 can provide functions such as volume up, volume down, next track and previous track; the center button 1008 can provide a play/pause function; and the other button 1010 can provide a menu request function. Moreover, other management type commands, such as pairing and unpairing, can be mapped to combinations of buttons to minimize the number of buttons and to avoid accidental management commands. For example, pressing the other button 1010 together with the center button 1008 can request pairing, and pressing the other button 1010 together with a particular one of the four input buttons 1006 can request unpairing

The various aspects, embodiments, implementations or features of the invention can be used separately or in any combination.

The invention can be implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that like remote controllers can be provided to control a wide range of different host devices, simultaneously and in the same line-of-sight vicinity, yet they can be associated so as to control only a particular one of the host devices. Another advantage of the invention is that the remote controllers can be highly portable, low power, wireless devices with simplified user input controls.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for associating a portable remote controller to one of a plurality of host devices, said method comprising:
temporarily disabling all but a desired one of the host devices from receiving wireless transmissions from the portable remote controller;
receiving a user interaction with the portable remote controller to provide a pairing request;
wirelessly transmitting the pairing request from the portable remote controller;
receiving the pairing request at the desired one of the host devices but not at any of the other host devices; and
pairing the portable remote controller to the desired one of the host devices.

2. A method as recited in claim 1, wherein the pairing request includes a device identifier for the portable remote controller, and
wherein said pairing comprises:
storing the device identifier of the portable remote controller at the desired one of the host devices.

3. A method as recited in claim 2, wherein said method further comprises:
receiving at least one subsequent request from the portable remote controller or another portable remote controller;
determining whether a device identifier provided in or with the subsequent request matches the stored device identifier at the desired one of the host devices; and
ignoring the subsequent request unless said determining determines that the device identifier provided in or with the subsequent request matches the stored device identifier.

4. A method as recited in claim 2, wherein said method further comprises:
receiving, at the desired one of the host devices, an unpairing request from the portable remote controller; and
deleting the stored device identifier from the desired one of the host devices in response to the unpairing request.

5. A method as recited in claim 4,
wherein when said pairing is performed, the desired one of the host devices enters a paired state, and
wherein following said deleting, the desired one of the host devices enters an unpaired state.

6. A method as recited in claim 1, wherein said method further comprises:
receiving a user interaction with the portable remote controller to provide a change identifier request;
changing the device identifier of the portable remote controller in response to the change identifier request; and
storing the changed device identifier at the portable remote controller.

7. A method as recited in claim 1, wherein said wirelessly transmitting is over an infrared link.

8. A method for receiving and processing a user command at a host device, the user command being wirelessly transmitted from a portable remote controller to the host device, said method comprising:
receiving at least the user command and a device identifier that were transmitted from the portable remote controller to the host device in a wireless manner, where the device identifier pertains to the portable remote controller;
comparing the received device identifier with a previously stored device identifier at the host device; and
executing the received user command when said comparing indicates that the received device identifier matches the previously stored device identifier, and not executing the received user command when said comparing indicates that the received device identifier does not match the previously stored device identifier.

9. A method as recited in claim 8, wherein the wireless transmission is an infrared transmission.

10. A method as recited in claim 8, wherein the host device is a computer, a media device, a dock for an electronic device, or other electronic device.

11. A method as recited in claim 8, wherein the received user command pertains a media playback action to be performed by the host device.

12. A method as recited in claim 11, wherein the host device is a media player.

13. A method for associating a portable remote controller to a host device, said method comprising:
receiving a user input with respect to the portable remote controller;
identifying a command associated with the user input;
transmitting a control packet to the host device, the control packet including at least the command and a device identifier;
receiving the control packet at the host device;
acquiring at least the received command and the received device identifier from the received control packet;
comparing the received device identifier with a previously stored device identifier at the host device; and
executing the received command when said comparing indicates that the received device identifier matches the previously stored device identifier, and not executing the received command when said comparing indicates that the received device identifier does not match the previously stored device identifier.

14. A method as recited in claim 13, wherein the portable remote controller is an infrared portable remote controller, and wherein said transmitting is infrared transmission.

15. A method as recited in claim 13, wherein the host device is a computer, a media device, a dock for an electronic device, or other electronic device.

16. A method as recited in claim 13, wherein the received command pertains a media playback action to be performed by the host device.

17. A method as recited in claim 16, wherein the host device is a media player.

18. A method as recited in claim 13, wherein the portable remote controller is battery powered, and
wherein said method further comprises:
determining whether a low battery condition exists at the portable remote controller; and
transmitting a subsequent packet to the host device when the low battery condition exists, the subsequent packet including at least a low battery indication.

19. A method as recited in claim 18, wherein the subsequent packet is transmitted to the host device after the control packet is transmitted.

20. A method as recited in claim 13, wherein the portable remote controller is battery powered, and
wherein said method further comprises:
determining whether the user input is a particular event; and
when said determining determines that the user input is the particular event, determining whether a low battery condition exists at the portable remote controller, and transmitting a subsequent packet to the host device when the low battery condition exists, the subsequent packet including at least a low power indication.

21. A method as recited in claim 20, wherein the user input is associated with pressing at least one button on the portable remote controller, and wherein the particular event is a button release event.

22. A wireless control system for remotely controlling a host device by a portable remote controller, said system comprising:
a portable remote controller including at least:
a user input device for receiving a user input;
a persistent memory that stores a device identifier for said portable remote controller;
a controller for identifying a command associated with the user input; and
a transmitter for transmitting a control packet to the host device, the control packet including at least the command and the device identifier; and
a host device including at least:
a receiver for receiving the control packet; and
a controller for (i) acquiring at least the received command and the received device identifier from the received control packet, (ii) comparing the received device identifier with a previously stored device identifier at the host device, and (iii) executing the received command when the comparing indicates that the received device identifier matches the previously stored device identifier, and not executing the received command when the comparing indicates that the received device identifier does not match the previously stored device identifier.

23. A method as recited in claim 22, wherein the host device is a media device, and wherein the received command pertains to a media playback action to be performed by the media device.

24. A computer readable medium including at least computer program code for receiving and processing a user command at a host device, the user command being wirelessly transmitted from a portable remote controller to the host device, said computer readable medium comprising:
computer program code for receiving at least a user command and a device identifier that were wirelessly transmitted from the portable remote controller to the host device, the device identifier pertaining to the portable remote controller; and
computer program code for executing the received command only when the received device identifier matches the previously stored device identifier.

25. A computer readable medium including at least computer program code for associating a portable remote controller to one of a plurality of host devices, said computer readable medium comprising:
computer program code for configuring a desired one of the host devices to pair with a portable remote controller;
computer program code for receiving a request at the desired one of the host devices, the request being provided via wireless transmission from the portable remote controller; and
computer program code for at least pairing the portable remote controller to the desired one of the host devices in response to the request.

26. A computer readable medium as recited in claim 24, wherein the request includes a device identifier for the portable remote controller, and
wherein said computer program code for pairing comprises:
computer program code for storing the device identifier of the portable remote controller at the desired one of the host devices.
